(19) United States
(12) Patent Application Publication
(10) Pub. No.: US 2002/0112163 A1
(43) Pub. Date: Aug. 15, 2002

(54) Ensuring legitimacy of digital media

(76) Inventor: Mark Ireton, Portland, OR (US)

Correspondence Address: FENWICK & WEST LLP, TWO PALO ALTO SQUARE, PALO ALTO, CA, 94306, US

(21) Appl. No.: 09/783,244

(22) Filed: Feb. 13, 2001

(51) Int. Cl. H04L 9/00

(52) U.S. Cl. 713/176

(57) ABSTRACT

One embodiment of the present invention provides a system for verifying the legitimacy of a digital media file, including an analysis module for determining control information associated with the digital media file and for computing a known hash value that uniquely identifies the digital media file, and a verification module for computing a verification hash value from the analyzed digital media file received, and for comparing that verification hash value to the known hash value to verify the analyzed digital media file received has not been compromised. Another embodiment of the present invention provides a method for verifying the legitimacy of a digital media file previously established as legitimate.

### FIELD OF THE INVENTION

The invention relates to digital media, and more particularly, to ensuring the legitimacy of digital media content.

### BACKGROUND OF THE INVENTION

Digital media can represent information in a number of forms, including the likes of audio, video, software, text, graphics, or combinations thereof. As such digital media proliferates and is distributed to consumers, various protection mechanisms are developing to ensure that digital media is not subjected to unintended or illegal use, such as unauthorized copying and redistribution.

For example, a piece of digital media content might have a digital watermark embedded within or otherwise associated with the digital media content. A digital watermark is a digital code that is generally hidden (e.g., unseen or inaudible) from the user of the digital media that is being protected, and identifies control information relevant to copyright protection and data authentication. More specifically, digital watermarking allows the likes of the source, author, creator, owner, distributor, usage rights, transaction trail including the original transaction, and the authorized consumer of the digital content to be verified. Analyzing a watermark, however, can be a very complex process.

Encryption techniques can also be used to protect digital media. Once a piece of digital media is received, it can be encrypted with any one of a number of available encryption algorithms and then stored in its encrypted state. The digital media can then be safely transferred to a playback device and decrypted with a corresponding decryption algorithm so that it can be played back or otherwise used. However, encrypting the digital media requires a second copy of the digital media to be stored assuming it is desirable to maintain the originally received copy (e.g., unencrypted with a digital watermark embedded therein) for local use, as well as an encrypted copy for remote use (e.g., on a portable music player). Thus, the memory requirement is doubled.

There is a need, therefore, for a technique that allows the legitimacy of digital media content to be easily verified. Likewise, there is a need for a technique for protecting digital media content without having to store encrypted copies.

### BRIEF SUMMARY OF THE INVENTION

One embodiment of the present invention provides a system for verifying the legitimacy of a digital media file, the system including an analysis module for determining control information associated with the digital media file and for computing a known hash value that uniquely identifies the digital media file, thereby yielding an analyzed digital media file, and a verification module adapted to receive the analyzed digital media file (e.g., in response to a request or automatic inventory check), and for computing a verification hash value from the analyzed digital media file received, and for comparing that verification hash value to the known hash value to verify the analyzed digital media file received has not been compromised.

Another embodiment of the present invention provides a method for verifying the legitimacy of a digital media file previously established as legitimate, by retrieving the digital media file, computing a verification hash value from the retrieved digital media file, comparing the verification hash value to a known hash value previously associated with the stored digital media file. In response to determining that the verification hash value matches the known hash value, the method further includes using the digital media file in accordance with control information associated with the digital media file.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a block diagram of a system for ensuring the legitimacy of a digital media file in accordance with one embodiment of the present invention.

FIG. 2 illustrates a method for verifying a digital media file is legitimate in accordance with one embodiment of the present invention.

FIG. 3 illustrates a method for analyzing a digital media file in accordance with one embodiment of the present invention.

### DETAILED DESCRIPTION OF THE INVENTION

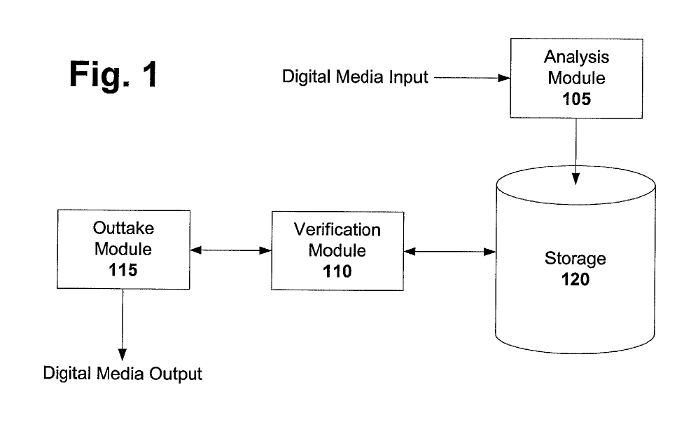

FIG. 1 illustrates a block diagram of a system for ensuring the legitimacy of a digital media file in accordance with one embodiment of the present invention. The system includes an analysis module 105, a verification module 110, an outtake module 115, and a storage 120. Such a system might be included, for example, in a conventional computer system, server or other processor-type environment. Alternatively, such a system might exist in a stand alone unit or integrated circuit specifically designed for carrying out the present invention. Each of the components shown, whether alone or in combination, can be implemented by the likes of hardware, software, firmware or any combination thereof.

System Overview

Digital media (e.g., audio, video, software, text, graphics, or combinations thereof) is input to the system (e.g., via analysis module 105). The source of such digital media can be local (e.g., ripped from a CD player included in the system) or remote (e.g., downloaded from an online digital media content provider). Once a piece of digital media is received by the system, it is analyzed to determine its control information (e.g., usage rules and other copyright information). For example, a digital watermark screen can be performed. Other associated properties can be determined as well, such as file name, size, and or type. Such control information and properties can be used to establish the legitimacy of the associated digital media. In addition, a unique identifier (e.g., a hash value) is computed for the piece of digital media. The unique identifier, control information (or a portion thereof, such as usage rights only) and other properties associated with the piece of digital media can be securely stored in a database or other storage means. The piece of digital media can also be stored, but it need not be encrypted (although it can be encrypted if so desired).

In response to a request to use the digital media (e.g., for playback at some location), it can be retrieved from storage. A verification process can then be performed by recomputing the unique identifier for the retrieved digital media. If the recomputed unique identifier matches the stored unique identifier, then it can be assumed that the digital media is still legitimate and was not replaced or otherwise tampered with while in storage. In one embodiment, this verification is effected by comparing a known hash value (the stored unique identifier previously associated with the digital media during the initial analysis) to a verification hash value computed from the received digital media (the recomputed unique identifier). Other information can be used to ensure a robust identification process. For example, the name, file type and or size of the digital media can also be compared. In addition, note that other mechanisms can be used to uniquely identify a particular piece of digital media (e.g., digital signature).

If the verification indicates the digital media is not compromised, then its associated control information can be retrieved. The digital media can be used pursuant to that control information. The use can be local or remote, and outtake processing of the digital media can be specific to the type of use. For example, if the use is local, then the digital media need not be encrypted by outtake processing. However, if the use is remote, then the digital media can be encrypted real-time by outtake processing prior to transfer to the remote location to ensure a secure transfer. Thus, the digital media need not be stored in an encrypted form. If, on the other hand, verification indicates the digital media has been compromised, then the digital media can be discarded or otherwise restricted from use. Alternatively, the digital media can be reanalyzed (e.g., perform a digital watermark screen) to determine if it is a legitimate copy. In such an embodiment, the compromised digital media is treated as if it is a new piece of digital media just received by the system.

Thus, each piece of digital media received by the system is associated with a unique identifying mechanism (e.g., digital signature) and control information (e.g., number of copies allowed). Once a unique identifier is assigned to a particular piece of digital media, any unauthorized manipulation, change or tampering with that digital media will be revealed by a nonconforming identifier. The unique identifying mechanism allows the legitimacy of the digital media to be verified without having to do a comprehensive analysis, such as a watermark screen.

Components

Analysis module 105 is adapted to determine the control information associated with received digital media. Analysis module 105 can, for example, perform a digital watermark screen or other comprehensive digital file screen to verify that the received digital media is legitimate, and to identify any associated usage rights. Default usage rights can be assigned in the event that the received digital media has no usage rights. In one embodiment, analysis module 105 performs a parallel process of computing a hash value that uniquely identifies the received digital media. This hash value and the control information (or a portion thereof) can be securely stored in storage 120. Likewise, the associated piece of digital media can be stored in storage 120. The secure hash value allows the digital media to be stored unencrypted because if the stored digital media is tampered with (e.g., replaced with an illegitimate copy), its associated hash value will be compromised. Thus, unauthorized activity can be detected.

Verification module 110 is adapted to receive requested digital media from storage 120, and to determine the unique identifier from the digital media. In one embodiment, verification module 110 includes a predetermined hash function that, when executed on a piece of digital media, produces a verification hash value for that particular piece of digital media. The range of the hash function is such that the chances of another piece of digital media producing the same hash value is extremely small and unlikely. For example, a 128 bit hash function has 3.402823669209e+38 possible values. The number of hash bits depends on factors such as the desired robustness and processing capability of the system. In an alternate embodiment, the unique identifier is realized with a digital signature associated with the digital media file. In such an embodiment, verification module 110 could analyze the digital signature.

Generally, a hash function is an algorithm that produces a digital representation or identifier from a digital file. This identifier is referred to as a hash value. The hash value is unique to that digital file and has a length that is typically much smaller than the digital file. Any change to the digital file produces a different hash result when the same hash function is used. Thus, such a hash value can be used to uniquely identify a particular digital file. In addition, hash functions allow digital signature algorithms to operate on smaller amounts of data, while maintaining robust security for the original digital file content. For instance, digital signature creation can use a unique hash value derived from both the signed digital file and a given private key. Other hash-based security mechanisms will be apparent to those skilled in the art in light of this disclosure.

Regardless of the means for realizing the unique identifier, verification module 110 determines the verification identifier for a requested piece of digital media and then compares that verification identifier to a known identifier securely stored, for example, in storage 120. If the verification identifier computed for the requested piece of digital media matches the known identifier, then that piece of digital media is legitimate. Once a verification identifier is matched, other criteria can be compared to further ensure robustness and accurate identification. For example, the known identifier in storage 120 can be associated with a file name, size and or type. Such criteria, which can also be stored in storage 120, can be compared to that of the piece of digital media. If the verification identifier or any other identifying criteria of the received digital media do not match the known criteria in storage 120, then verification module 110 can call or otherwise signal analysis module 105 to take control, and a full comprehensive reanalysis can be performed.

Outtake module 115 is adapted to transfer digital media verified as legitimate to other locations in the system, such as playback locations. The transfer may be to a local or remote location. Assuming that a requested piece of digital media is verified as legitimate, then the control information associated with that digital media can be provided (e.g., from storage 120) to outtake module 115, for example, by verification module 110 or directly from storage 120. Outtake module 115 can then interpret the control information and use the associated digital media accordingly. For example, if the control information indicates that two copies can be made, then outtake module 115 can make a copy of the digital media for transfer so that the original copy can be returned to storage 120 (e.g., along with updated usage rights). If the control information indicates that only one copy of its associated digital media is allowed, then that copy can be transferred by outtake module 115.

Note that if a number of usage rights are associated with a particular piece of digital media, then it will typically be necessary to decrement the copy count or otherwise update the usage rights on the source system when a copy of the associated digital media file is transferred to another location. Further, note that the making of copies can be restricted based on usage rights such as the local copy count. For example, if the local copy count is not greater than zero, then no copies can be made. The copy count at the destination can be accordingly increased by the number of usage rights transferred. In addition it is possible to transfer the digital media content, but without any of its associated usage rights. In such an embodiment, the associated usage rights or right could be transferred at some later time prior to usage of the digital media content at the new location.

If the transfer is to a local location (e.g., within a secure system), then the digital media need not be encrypted as it will not be vulnerable to tampering in transit. For example, outtake module 115 can convert a digital music file to its analog equivalent and provide that analog equivalent to an amplifier and speaker assembly included in the system (e.g., as part of the outtake module 115). On the other hand, if the transfer is to a remote location (e.g., to a portable device that can be used outside the system), then the digital media can be encrypted real-time as part of the transfer process performed by outtake module 115. Alternatively, a real-time encryption module can be operatively coupled to the remote output of outtake module 115. Note that the functionality of outtake module 115 can alternatively be incorporated into verification module 110.

Storage 120 can be, for example, a magnetic hard drive or a compact disk drive configured to record. Alternatively storage 120 can be a number of solid-state storage devices such as electronic erasable programmable read only memory (EEPROM) chips or flash memory chips. Other suitable storage devices and means will be apparent in light of this disclosure. In one embodiment, storage 120 or a portion of storage 120 includes a secure database for storing the likes of control information, hash values, digital signatures, name, size, and or type. The associated digital media can be stored in a non-secure portion of the database or the secure portion to preserve its unencumbered format for local use.

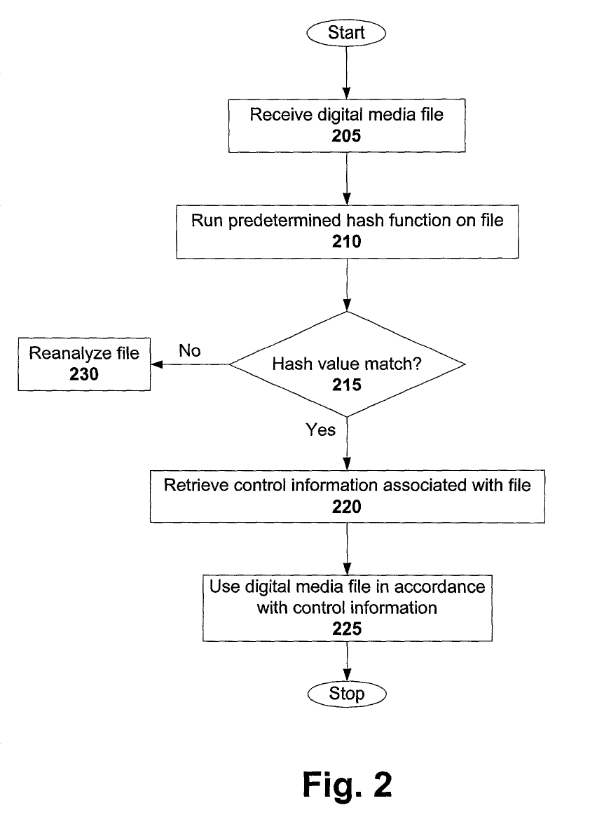

FIG. 2 illustrates a method for verifying a digital media file is legitimate in accordance with one embodiment of the present invention. This method can be effected, for example, by verification module 110 included in the system discussed with reference to FIG. 1. However, the present invention is not intended to be limited to any one specific embodiment. Rather, the method can be implemented in a number of computing or processing environments as will be recognized in light of this disclosure. For instance, this method could be implemented by a microcontroller unit configured to receive digital media files and having a verification process running therein.

The method includes receiving 205 a digital media file. In one embodiment, the digital media file is received from a database or other storage means in response to a user request for that digital media file. For instance, a user may have selected the digital media file for local playback, or for downloading to a portable playback device. The method continues with running 210 a predetermined hash function on the received digital media file so as to compute a verification hash value. Once a verification hash value is computed for the received digital media file, the method includes determining 215 if the verification hash value matches a known hash value previously associated with the digital media file. This known hash value, which can be computed in conjunction with a comprehensive analysis (e.g., digital watermark screen), can be securely stored in the likes of a database and associated with the digital media file. Other criteria associated with the digital media file can be compared and verified as well as explained above to ensure robustness and accuracy.

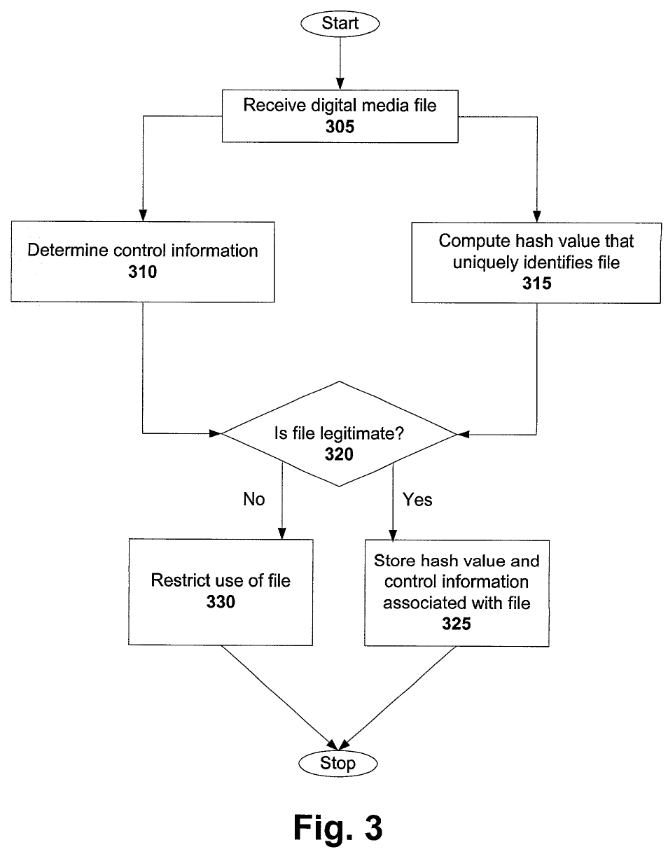

In response to the verification hash value matching the known hash value, the method includes retrieving 220 control information associated with the verified digital media file, and using 225 the digital media file in accordance with the control information. Such control information (e.g., usage rights) can also be securely stored in the database. However, in response to the verification hash value not matching the known hash value, the method may include reanalyzing 230 the received digital media file. Such analysis will be explained in more detail with reference to FIG. 3. As an alternative to reanalysis, use of the received digital media file can be restricted. For example, the digital media file can be deleted or otherwise removed from use. Likewise, the system user can be prompted with a pop up message (e.g., on a display included in the system) indicating the illegality of the digital media file, and providing remedial instructions or options (e.g., “Contact content provider to confirm legal acquisition of this product”).

FIG. 3 illustrates a method for analyzing a digital media file in accordance with one embodiment of the present invention. This method can be effected, for example, by analysis module 105 included in the system discussed with reference to FIG. 1. However, the present invention is not intended to be limited to any one specific embodiment. Rather, the method can be implemented in a number of computing or processing environments as will be recognized in light of this disclosure. For instance, this method could be implemented by a microcontroller unit configured to receive digital media files and having an analyzing process running therein.

The method begins by receiving 305 a digital media file. The source of such digital media can be local, such as from a CD player or storage included in the system. For example, the received digital media file can be from storage 120, and is being submitted for reanalysis because it failed verification. Alternatively, the source of such digital media can be remote, such as downloaded from an online digital media content provider.

The method further includes determining 310 control information associated with the digital media file, and computing 315 a hash value that uniquely identifies the digital media file. Note that steps 310 and 315 can be performed in parallel. The control information can be, for example, derived from a digital watermark (e.g., via performing a digital watermark screen) embedded in the digital media file or otherwise associated with the digital media file, and can be used to establish the legitimacy of the digital media file. In an alternative embodiment, steps 310 and 315 need not be performed in parallel. Whether or not parallel processing is employed depends on factors such as desired system response time and available processing power. The method proceeds with determining 320 if the digital media file is legitimate.

In response to the digital media file being legitimate, the method includes storing 325 the computed hash value and control information (e.g., usage rights only or all the control information) associated with digital media file. In one embodiment, the computed hash value and control information associated with the digital media file can be securely stored in a database or other storage facility. For instance, the hash value and control information can be encrypted, digitally signed or otherwise protected. Such protection can be effected, for example, upon each individual piece of data, groups of data, or on the whole database. In response to the digital media file not being legitimate, the method includes restricting 330 the use of the file. For example, the digital media file could be deleted or otherwise rendered unusable. In addition, the user could be notified of the illegality of the digital media file.

The foregoing description of the embodiments of the invention has been presented for the purposes of illustration and description. It is not intended to be exhaustive or to limit the invention to the precise form disclosed. Many modifications and variations are possible in light of the above teaching. For example, properties associated with the stored digital media (e.g., name, size, type) can be determined real-time rather than storing such properties. It is intended that the scope of the invention be limited not by this detailed description, but rather by the claims appended hereto.

What is claimed is:

1. A system for ensuring the legitimacy of a digital media file, the system comprising:
an analysis module for determining control information associated with the digital media file and for computing a known hash value that uniquely identifies the digital media file, thereby yielding an analyzed digital media file;
a storage operatively coupled to the analysis module, and for securely storing the known hash value and the control information associated with the analyzed digital media file;
a verification module operatively coupled to the storage and adapted to receive the analyzed digital media file, the verification module for computing a verification hash value from the analyzed digital media file received, and comparing that verification hash value to the known hash value; and
an outtake module adapted to transfer the analyzed digital media file in accordance with the associated control information in response to the verification hash value matching the known hash value.

2. The system of claim 1, wherein the analysis module further determines properties of the analyzed digital media file including at least one of file name, file size and file type, and stores those properties in the storage.

3. The system of claim 2, wherein the verification module compares at least one stored property of the analyzed digital media file with a corresponding actual property of the analyzed digital media file received.

4. The system of claim 1, wherein in response to the verification hash value not matching the known hash value, use of the analyzed digital media file is restricted.

5. The system of claim 1, wherein in response to the verification hash value not matching the known hash value, the verification module signals the analysis module to perform a reanalysis of the analyzed digital media file received.

6. The system of claim 1, wherein the analysis module determines the control information by performing a digital watermark screen.

7. The system of claim 1, wherein the control information includes usage rights associated with the digital media file.

8. The system of claim 1, wherein in response to no control information being associated with the digital media file, the analysis module assigns default usage rights to the digital media file.

9. The system of claim 1, wherein the determining of the control information and the computing of the known hash value are performed in parallel by the analysis module.

10. The system of claim 1, wherein the analyzed digital media file is stored unencrypted in the storage.

11. The system of claim 1, wherein the outtake module performs real-time encryption on the digital media file before transfer.

12. A system for verifying the legitimacy of a digital media file, the system comprising:
an analysis module for determining control information associated with the digital media file and for computing a known hash value that uniquely identifies the digital media file, thereby yielding an analyzed digital media file; and
a verification module adapted to receive the analyzed digital media file, and for computing a verification hash value from the analyzed digital media file received, and for comparing that verification hash value to the known hash value to verify the analyzed digital media file received has not been compromised.

13. The system of claim 12, wherein in response to the verification hash value not matching the known hash value, use of the analyzed digital media file is restricted.

14. The system of claim 12, wherein in response to the verification hash value not matching the known hash value, the verification module signals the analysis module to perform a reanalysis of the analyzed digital media file received.

15. The system of claim 12, wherein the analyzed digital media file is stored unencrypted in a storage.

16. The system of claim 12, further comprising:
an outtake module adapted to transfer the analyzed digital media file in accordance with the associated control information in response to the verification hash value matching the known hash value.

17. The system of claim 16, wherein the outtake module performs real-time encryption on the digital media file before transfer.

18. The system of claim 12, further comprising:
a storage operatively coupled to the analysis and verification modules, and for securely storing the known hash value and the control information associated with the analyzed digital media file.

19. The system of claim 12, wherein the system is contained on a computer readable medium in the form of software instructions.

20. A method for verifying the legitimacy of a stored digital media file previously established as legitimate, the method comprising:
retrieving the stored digital media file;
computing a verification hash value from the retrieved digital media file;
comparing the verification hash value to a known hash value previously associated with the stored digital media file as part of a comprehensive analysis in establishing the legitimacy of the digital media file; and
in response to determining that the verification hash value matches the known hash value, using the digital media file in accordance with control information associated with the digital media file.

21. The method of claim 20, wherein the control information is included in a digital watermark associated with the digital media file.

22. The method of claim 20, wherein the comprehensive analysis in establishing the legitimacy of the digital media file includes performing a digital watermark screen.

23. The method of claim 20, further comprising:
in response to the digital media file not being legitimate, restricting the use of the digital media file.

24. The method of claim 20, wherein the stored digital media file is unencrypted.

25. A method for verifying a digital media file previously established as legitimate has not been compromised, the method comprising:
running a predetermined hash function on the digital media file thereby computing a verification hash value;
determining if the verification hash value matches a known hash value previously associated with the digital media file;
in response to the verification hash value matching the known hash value, retrieving control information associated with the digital media file; and
using the digital media file in accordance with the control information.

26. The method of claim 25, wherein the digital media file is received from a database in response to a user request for that digital media file.

27. The method of claim 25, further comprising:
securely storing the known hash value associated with the digital media file.

28. The method of claim 25, further comprising:
securely storing usage rights defined by the control information associated with the digital media file.

29. The method of claim 25, further comprising:
in response to the verification hash value not matching the known hash value, reanalyzing the received digital media file.
